(19) United States
(12) Patent Application Publication
(10) Pub. No.: US 2002/0029911 A1
(43) Pub. Date: Mar. 14, 2002

(54) Patient weighing apparatus

(76) Inventor: John H. Richards, Warrington, PA (US)

Correspondence Address: BARNES & THORNBURG, 11 SOUTH MERIDIAN, INDIANAPOLIS, IN, 46204

(21) Appl. No.: 09/813,190

(22) Filed: Mar. 20, 2001

Related U.S. Application Data
(60) Provisional application No. 60/190,847, filed on Mar. 20, 2000.

(51) Int. Cl. G01G 19/52

(52) U.S. Cl. 177/144

(57) ABSTRACT

A scale includes a support surface and a plurality of weight modules oriented between the support surface and a base. Each of the weight modules produces at an output port thereof a signal. The weight modules are coupled to a host for providing an indication of the weight on the support surface. The signals are combined to produce an indication of the weight on the support surface.

### BACKGROUND AND SUMMARY OF THE INVENTION

This application claims the benefit of the filing date of U.S. provisional Application Ser. No. 60/190,847 filed on Mar. 20, 2000, as to all matters disclosed therein.

This invention relates to bed scales for determining the weights of patients while they are in bed. It is disclosed in the context of a bed scale for an incubator, but is believed to be useful in other applications as well.

Existing designs for bed scales for incubators include four weight modules and one tilt module. These are located between a metal base frame and a scale mattress tray. Each of the weight modules is located at one of the four comers of the scale platform assembly. Each weighs about one-fourth of the infant's weight. This information is output in analog form to the tilt module. The tilt module collects, filters and sums the outputs of the four weight modules and transmits the calculated infant weight to a host computer.

According to one aspect of the invention, a scale includes a support surface and a plurality of weight modules oriented between the support surface and a base. Each of the weight modules produces at an output port thereof a digital signal. The weight modules are coupled to a host for providing an indication of the weight on the support surface. The digital signals are combined to produce an indication of the weight on the support surface.

The apparatus may also include a tilt module to facilitate combination of the digital output signals from the multiple weight modules. The tilt module combines the output signals from the multiple weight modules. Tilt module may filter the output signals from the weight modules. Tilt module sums the output signals from the weight modules. At least one of the weight and/or tilt modules may include a Faraday cylinder for shielding the at least one module from electrical fields outside the Faraday cylinder. When more than one Faraday cylinder is used, the Faraday cylinders are electrically coupled to each other. This arrangement provides enhanced noise immunity for the system. Additionally, the weight modules can be individually calibrated before they are installed between the support and the base. This improves both initial assembly and field replacement of weight modules.

According to another aspect of the invention, a scale includes a support surface and a plurality of weight modules oriented between the support surface and a base. At least one of the weight modules includes a first Faraday cylinder for shielding the at least one weight module from electrical fields outside the first Faraday cylinder. The weight modules are coupled to a host for providing an indication of the weight on the support surface. Output signals from the weight modules are combined to produce an indication of the weight on the support surface.

According to another aspect of the invention, a scale includes a support surface, and a plurality of weight modules oriented between the support surface and a base. Each of the weight modules produces at an output port thereof a signal. The weight modules are coupled to a host to provide an indication of the weight on the support surface. A tilt module separates the signals from the weight modules into at least two components. One of the components corresponds to the weight determined by each weight module. The signals are combined to produce an indication of the weight on the support surface.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description particularly refers to the accompanying figures in which:

FIG. 1 illustrates a partly exploded perspective view of a system constructed according to the invention;

FIG. 2 illustrates an exploded bottom perspective view of a detail of the system illustrated in FIG. 1;

FIG. 3 illustrates a bottom perspective view of a detail of the system illustrated in FIG. 1;

FIG. 4 illustrates a partly block and partly schematic diagram of circuits useful in the system illustrated in FIG. 1 wherein the weight modules use microcontroller's not having on-chip memory;

FIG. 5 illustrates a partly block and partly schematic diagram of alternate circuits useful in the system illustrated in FIG. 1 wherein the weight modules use microcontroller's having on-chip memory;

FIG. 6 illustrates a partly block and partly schematic diagram of a circuit useful in the system illustrated in FIG. 1; and, FIG. 7 is a block diagram of the system illustrated in FIG. 1 including models implemented by the various microcontrollers.

### DETAILED DESCRIPTION OF AN ILLUSTRATIVE EMBODIMENT

A scale constructed according to the invention exhibits reduced weight and reduced cost by removing internal shielding, by removing a clamp-on ferrite filter, by reducing the sizes of the load cells, and by removing a bottom structural foam cover.

Resin, for example, Delrin® brand acetal resin, strips are provided at each end of the scale platform to aid in centering the scale platform in the incubator's mattress tray. This reduces measurement errors which result from the scale platform rubbing against the walls of the incubator.

Each weight module 32 includes a 2.5 kg load cell 34, a precision voltage reference 76, an instrumentation amplifier 84, a 24-bit Δ/ΣA/D converter 80, and a microcontroller (μC) 90 or 191. Depending on the μC 90 or 190, the weight module may or may not include a separate non-volatile memory 88. Each weight module 32 receives and processes commands from tilt module 50 to perform the load cell measurement. A start conversion command synchronizes the weight modules 32 to prevent measurement errors associated with infant movement. The non-volatile memory permits each weight module 32 to be calibrated and tested prior to inclusion in platform assembly 20. The large dynamic input range of each A/D converter 80 permits digital load cell calibration, compensating for both offset and load cell gain variability. This eliminates the current labor-intensive and expensive practice of custom selection and installation of load cell trimming resistors. In addition to load cell calibration data, the non-volatile memory contains serial number information. While the illustrated embodiment discloses an incubator bed scale having weight modules 32 and a tilt module 50, the weight modules 32 can be a common component in other patient scale products.

Tilt module 50 collects, combines and filters weight data from all weight modules 32 and transmits the result to the host 60 using, for example, RS232. Tilt module 50 includes power conditioning circuitry 102 and a μC 106. Illustratively, it also includes a tilt sensor 100 and its associated signal conditioning integrated circuit (IC) 102. Tilt sensor 100 permits a system 20 including it to measure the mattress angle, or degree of tilt, and compensate for errors in the weight measurement due to the tilt. This permits a system 20 to weigh accurately even though the system 20 is not in a perfectly horizontal orientation. Due to the relatively higher cost of tilt sensor 100 and its IC 102, tilt module 50 can be produced in two versions, one with the tilt sensor components mounted on a printed circuit board (PCB), and one without.

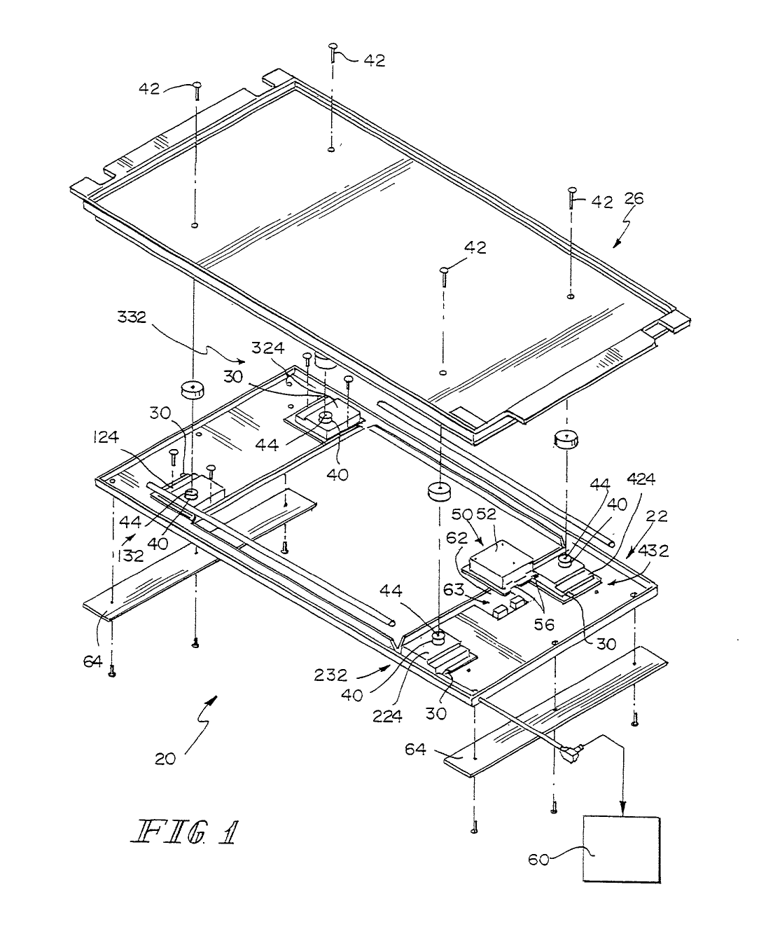

Referring now particularly to FIG. 1, an exploded perspective view of a scale platform assembly 20 is shown. Scale platform assembly 20 includes a base frame 22 and a number, n, four in the illustrated example, of weight module housings, referred to collectively or generically by reference numeral 24 and individually by reference numerals of the type n24, illustratively 124, 224, 324, 424. A similar reference numbering approach will be applied to individual components of weight modules 32. Those skilled in the art will recognize that fewer or more weight modules 32 may be used in accordance with the disclosure herein.

In the illustrated embodiment, one of the weight module housings 124, 224, 324, 424 is oriented in each quadrant of an infant mattress tray 26. Illustratively, the apparatus includes four weight modules 32 in a quadrilateral orientation between the support surface 26 and the base 22. Further illustratively, the four weight modules 32 are oriented in a rectangle between the support surface 26 and the base 22. Those skilled in the art will recognize that fewer or more weight modules 32 in non-rectangular orientations are within the scope of the disclosure.

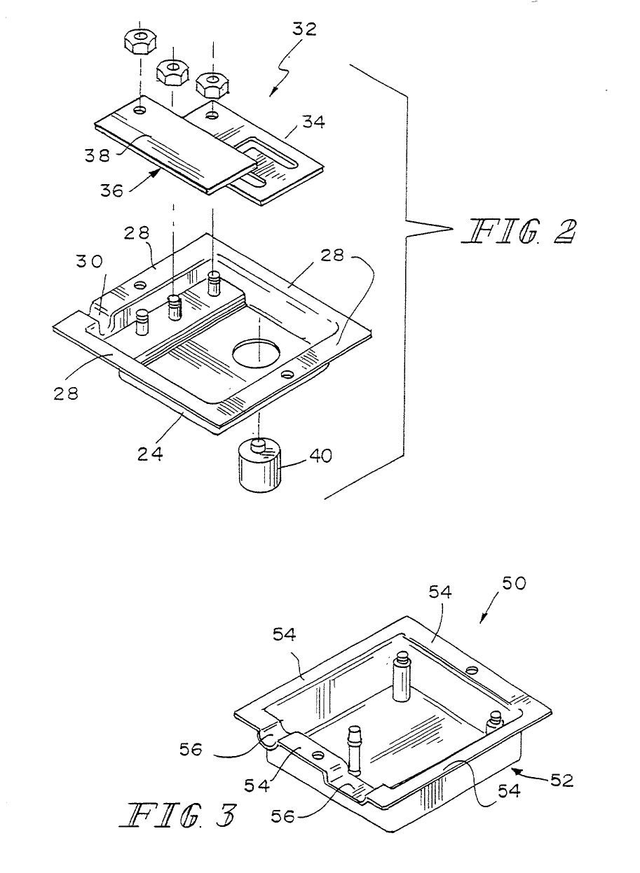

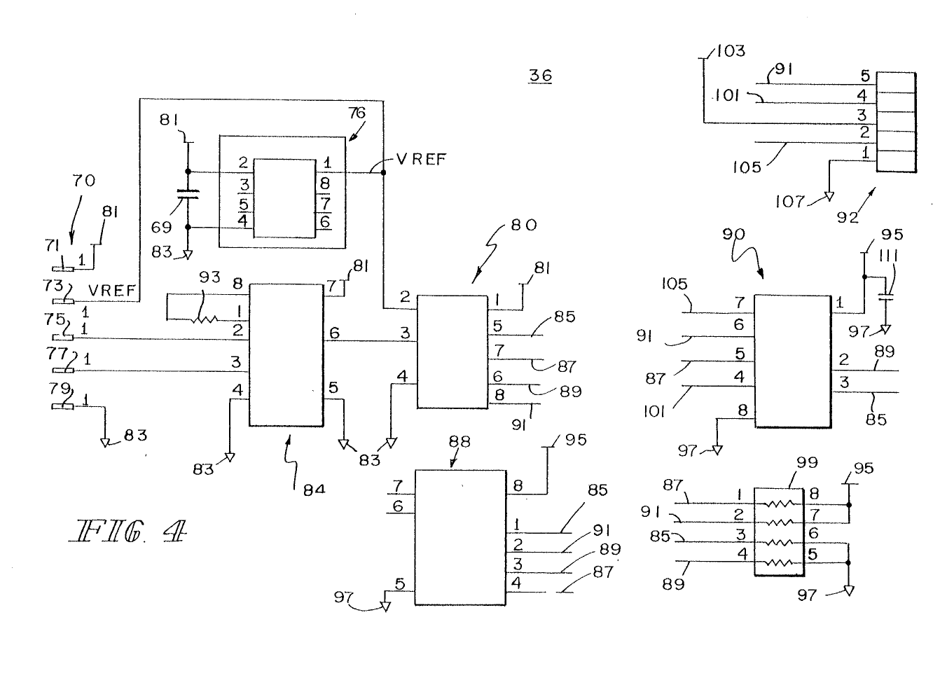

Referring particularly to FIG. 2, each weight module housing 24 is somewhat inverted basin-shaped, and includes a mounting flange 28 by which it is mounted to base frame 22. Each weight module housing 24, when so mounted, defines a passageway 30 between flange 28 and base frame 22 through which electrical conductors (not shown for purposes of simplification) for its respective weight module 32 pass. Illustratively, weight module housing 24 is fabricated from Aluminum 3003 H14 with a gold chromate finish. Base frame 22 is fabricated from aluminum alloy 5052-H32 with a gold chromate finish. Thus, weight module housing 24 and base frame 22 are fabricated from conductive material so that when weight module housing 24 is mounted to base frame 22, weight module housing 24 and frame 22 combine to form a Faraday cylinder.

Electrical components of each weight module 32 are housed in this Faraday cylinder to shield the components from electromagnetic interference generated by external components and to shield the external components from electromagnetic interference generated by the weight module components. Each weight module housing 24 is electrically coupled to each other weight module housing 24 through conductive base frame 22. Illustratively, base 22 is electrically coupled to ground potential. It is within the scope of the disclosure for base frame 22 and weight module housing 24 to be fabricated from other materials, however, if the benefits of shielding the electrical components are to be realized, such components should be fabricated and coupled so as to form a Faraday cylinder enclosing the electrical components of weight module 32.

Each weight module housing 24 houses a load cell 34 and an associated electrical circuit 36 or 136 (see also FIGS. 4 and 5) provided on a printed circuit board 38. Loads are transferred to the respective load cells 134, 234, 334, 434 through shock mounts 40 mounted by threaded studs on load cell 34. Infant mattress tray 26 is in turn mounted to the shock mounts 40 by respective threaded fasteners 42 which extend through openings in mattress tray 26 and into threaded openings 44 provided therefor on the top surface of load cell 34.

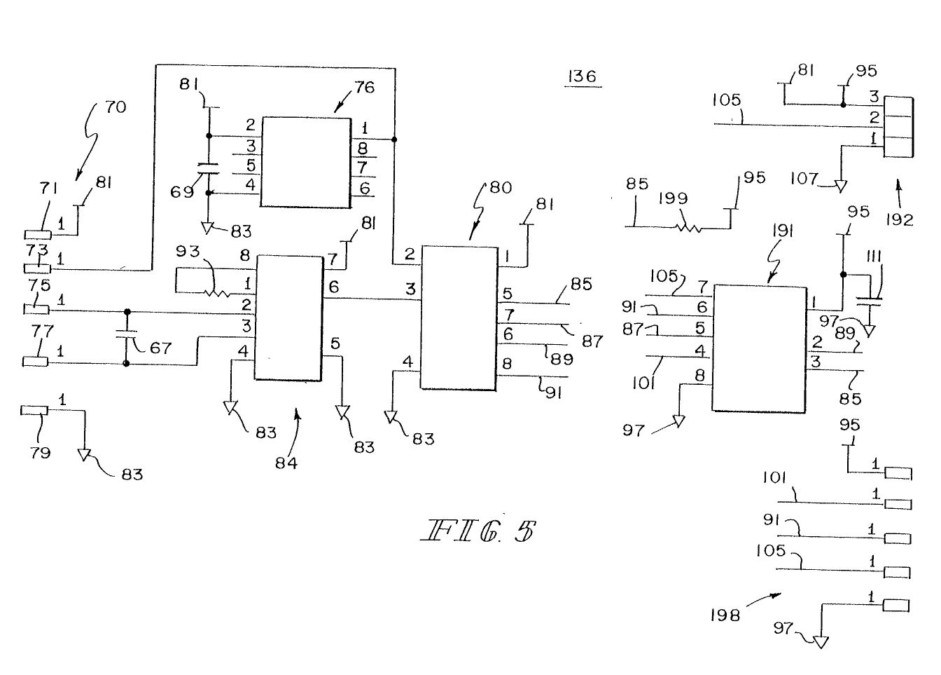

In addition to four weight modules 32, a tilt module 50 is mounted on the top surface of base frame 22. Referring particularly to FIG. 3, tilt module 50 includes a tilt module housing 52 which is also somewhat inverted basin-shaped, and includes a mounting flange 54 by which it is mounted to base frame 22. Tilt module 50, when so mounted, defines passageways 56 through which electrical conductors from weight modules 32 pass, and through which electrical conductors pass to a weigh system host 60 such as, for example, an Isolette® incubator controller, which receives the output from tilt module 50.

Illustratively, tilt module housing 52 is fabricated from Aluminum 3003 H14 with a gold chromate finish. Thus, tilt module housing 52 and base frame 22 are fabricated from conductive material so that when tilt module housing 52 is mounted to base frame 22, tilt module housing 52 and frame 22 combine to form a Faraday cylinder. Electrical components of tilt module 50 are housed in this Faraday cylinder to shield the components from electromagnetic interference generated by external components and to shield the external components from electromagnetic interference generated by the tilt module components. Tilt module housing 52 is electrically coupled to each weight module housing 24 through conductive base frame 22. It is within the scope of the disclosure for base frame 22 and tilt module housing 52 to be fabricated from other materials, however, if the benefits of shielding the electrical components are to be realized, such components should be fabricated and coupled so as to form a Faraday cylinder enclosing the electrical components of tilt module 50. Tilt module 50 includes a printed circuit board 62 on which are provided electrical circuits 63 (see also FIG. 5) associated with tilt module 50.

Assembly 20 includes a pair of mounting strips 64 constructed from, for example, Delrin® brand acetal resin. Strips 64 are mounted adjacent the ends 66 on the undersurface of base frame 22. Strips 64 frictionally engage the supporting base to reduce movement of base frame 22 to avoid contact between supporting surface 26 and sides of the incubator. By avoiding such contact, errors in the weight readings resulting from an upward component of force generated by the sides of the incubator on the support surface are eliminated.

In the detailed descriptions that follow, several integrated circuits and other components are identified by particular circuit types and sources. In many cases, terminal names and pin numbers for these specifically identified circuit types from these specific sources are noted. This should not be interpreted to mean that the identified circuits are the only circuits, or the only circuits available from the same, or any other, sources, that will perform the described functions. Other circuits are typically available from the same, and other, sources which will perform the described functions. The terminal names and pin numbers of such other circuits may or may not be the same as those indicated for the specific circuits identified in this application.

Turning now to FIG. 4, circuitry 36 associated with each weight module 32 includes five solder pads 70 for flat-flex soldering external connectors to five conductors which are designated Vex+ 71, Vref 73, Vsig− 75, Vsig+ 77 and Vex− 79. An external 5 volt supply having a first terminal 81 at five volts potential above analog ground terminal 83 is supplied from tilt module 50 via a pair of the conductors which couple each weight module 32 to tilt module 50. Vex+ 71 is Analog+ 5 volts with respect to Vex− 78, which is designated the assembly 20 Analog GrouND (AGND) 83. First terminal or A+5 V 81 is coupled to the INput terminal, pin 2, of a voltage regulator IC 76, such as, for example, a Linear Technologies type LTC1258-4.1, 4.1 volt regulator. A 10 μF capacitor 69 is coupled across the IN terminal of IC 76 and the GrouND (GND) terminal, pin 4, of IC 76. The GND terminal of IC 76 is coupled to AGND 83. A reference voltage of +4.1 V with respect to AGND 83 is provided on the OUTput terminal, pin 1, of IC 76. This reference voltage is coupled to the VREFerence input terminal, pin 2, of an A/D converter IC 80, such as, for example, a Linear Technologies type LTC2400C A/D converter.

The Vcc terminal, pin 1, of IC 80 is coupled to A+5 V 81. The notChipSelect, SerialCLocK, SerialDataOutput, and FO input terminals, pins 5, 7, 6 and 8, respectively, of IC 80, form circuit 36's GeneralPurpose4 (GP4) 85, GP2 87, GP5 89 and GP1 91 lines, respectively. The GND terminal, pin 4, of IC 80 is coupled to AGND 83. The VINput terminal, pin 3, of IC 80 is coupled to the Output terminal, pin 6, of an amplifier IC 84 such as, for example, an Analog Devices type AD623 instrumentation amplifier. The Input− and Input+ terminals, pins 2 and 3, respectively, of IC 84 are coupled through Vsig− 75 and Vsig+ 77 across the signal terminals of the load cell 34 associated with that particular weight module 32.

The Vs- and Reference terminals, pins 4 and 5, respectively, of IC 84 are coupled to AGND 83. A 249Ω resistor 93 is coupled across the Rg+ and Rg− terminals, pins 8 and 1, respectively, of IC 84. The GP1 91, GP2 87, GP4 85 and GP5 89 lines are also coupled to the CLocK, DataOut, ChipSelect and DataIn terminals, pins 2, 4, 1 and 3, respectively, of a non-volatile memory IC 88 such as, for example, a Microchip type 93LC46B electrically erasable non-volatile memory IC. Digital+5 V 95 is coupled to the Vcc terminal, pin 8, of IC 88. The Vss terminal, pin 5, of IC 88 is coupled to DigitalGrouND (DGND) 97. GP1 and GP2 are also coupled through respective 10 KΩ pull-up resistors of a 10K, four resistor resistive network 99 to Digital+5 V 95 supply. GP4 85 and GP5 89 are also coupled through respective 10 KΩ pull-down resistors of a 10K, four resistor resistive network 99 to DGND 97. Circuit 36's GP4 85 and GP5 89 lines are coupled to the GP4 and GP5 terminals, pins 3 and 2, respectively, of the μC 90. The VDD terminal of μC 90 is coupled to D+5V 95 and through 10 μF capacitor 111 to DGND 97. The Vss terminal of μC 90 is coupled to DGND 97. A connector 92 from each weight module 32 to the tilt module 50 includes a CLocK terminal coupled to the circuit 36's GP1 line 91, a Vpp terminal coupled to the GP3 line 101, a +5V terminal coupled to the Power+5V line 103, a DaTA terminal coupled to the GP0 line 105, and a GrouND terminal coupled to the PowerGrouND (PGND) terminal 107.

The GP0-GP3 lines, 105, 91, 87, 101 respectively, of the weight module 32 are coupled to the GP0-GP3 terminals, pins 7-4, respectively, of a μC 90 or 191 such as, for example, a Microchip PIC12C508 μC or PIC12C518 μC.

If a μC 191, such as the PIC12C518, is used which has built-in non-volatile memory, then separate non-volatile memory IC 88 can be eliminated. This embodiment of circuit 136 is illustrated in FIG. 5. The same reference numbers are used to refer to the same components in each of FIGS. 4 and 5. Those skilled in the art will recognize that the elimination of the non volatile memory chip 88 in the circuit 136 of FIG. 5 results in other minor modifications of the circuitry. By comparing FIGS. 4 and 5, it can be seen that circuit 163 includes an additional 0.001 μF capacitor 67 coupling Vsig− and Vsig+. Also resistive network 99 is eliminated in circuit 136. A 10kΩ resistor 199 couples GP4 85 to D+5V 95 through the +5V pad of a programming pad 198. GP1 is coupled to CLK pad of programming pad 198. GP0 105 is coupled to the DTA pad of programming pad 198. GP3 101 is coupled to the VPP pad of programming pad 198. Instead of five pin connector 92, circuit 136 uses a three pin connector 192. A+5V and D+5v are coupled to the +5V pin of connector 192. GP0 105 is coupled to the DTA pin of connector 192 and PGND 107 is coupled to the GND pin of connector 192.

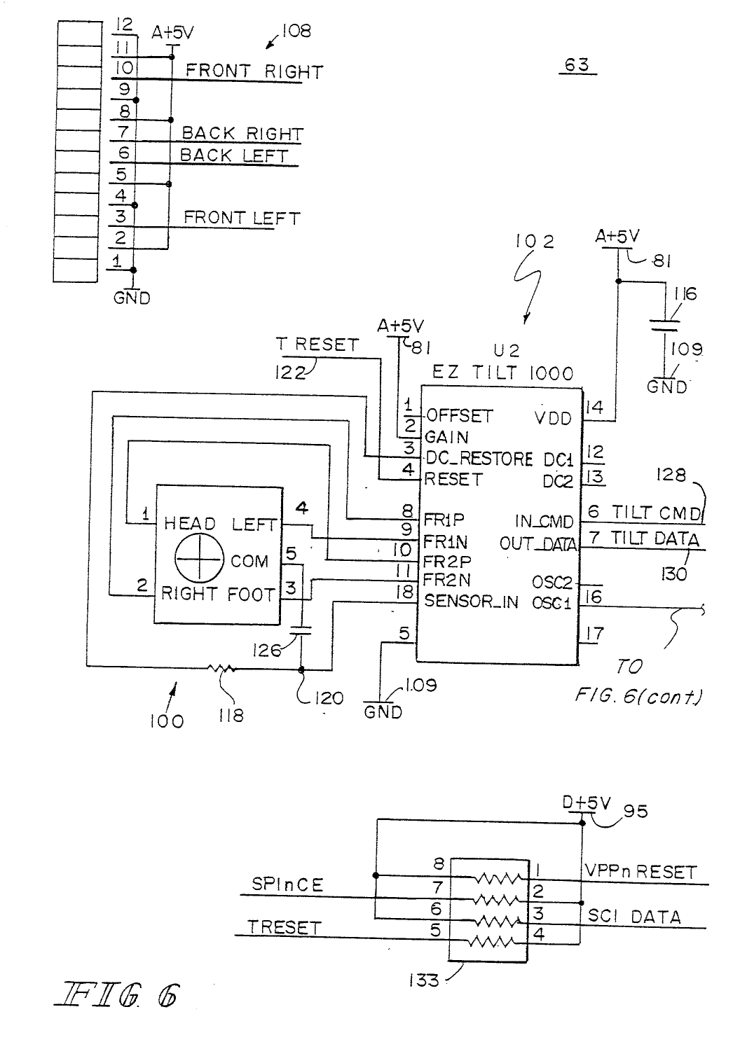

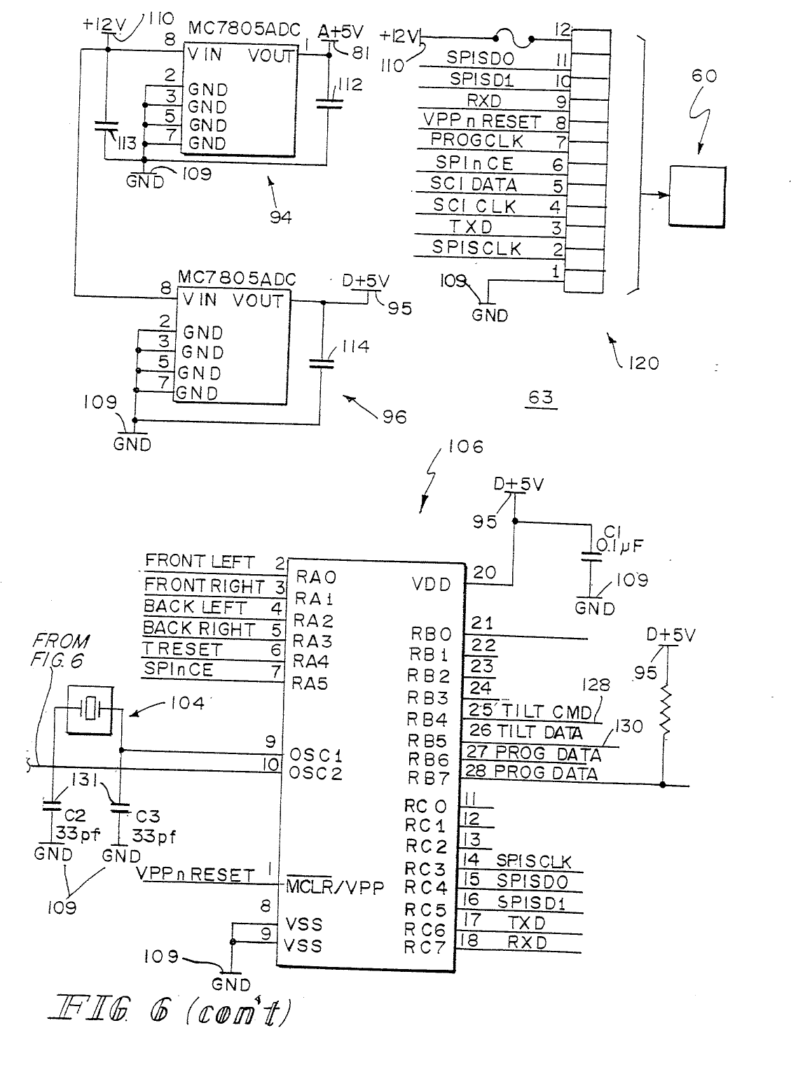

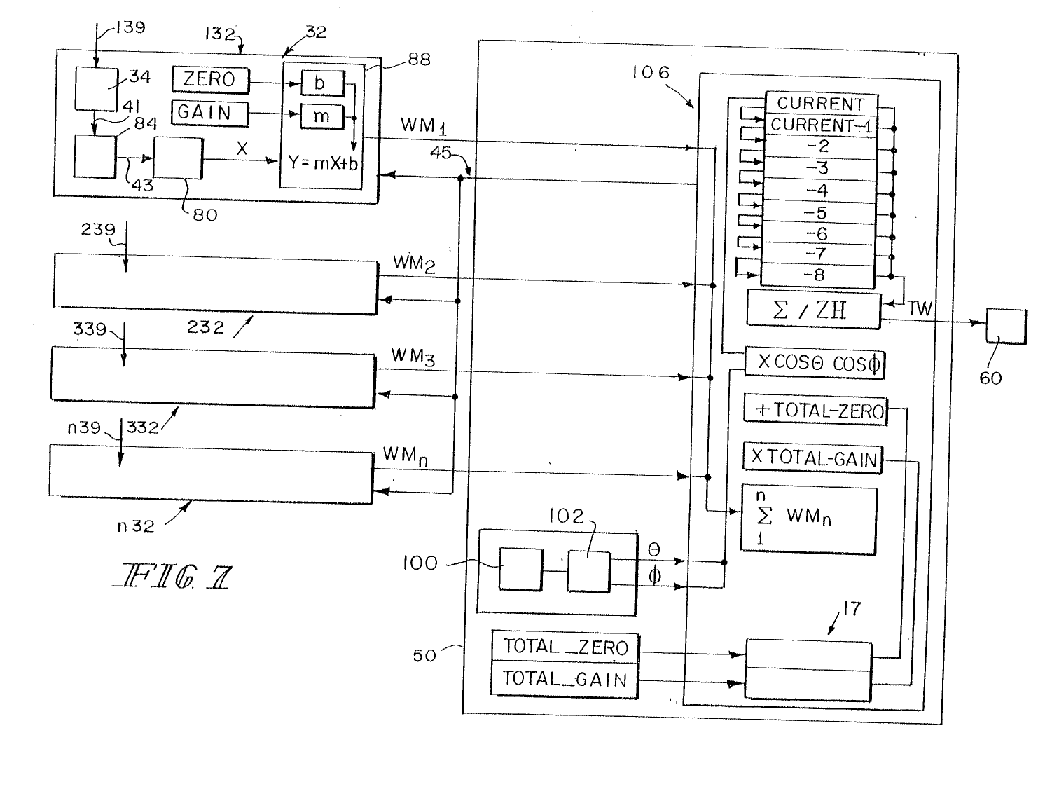

Turning now to FIG. 6, tilt module circuit 63 includes the voltage supplies for both Analog 81 and Digital 95 +5V. These are integrated circuit voltage regulators 94 and 96, respectively. Both illustratively are Motorola type MC7805ADC voltage regulators. A +12 V input voltage 110 is coupled to the VINput terminals of both voltage regulators 94 and 96 and through 10 μF capacitor 113 to GND 109. The output voltages at terminals VOUTput of both devices are at A+5V 81 and D+5V 95, respectively. Illustratively, VOUT pin of voltage regulator 94 provides A +5V 81 and is coupled through a 0.1 μF capacitor 112 to ground 109. Similarly, VOUT pin of voltage regulator 96 provides D +5V 95 and is coupled through a 0.1 μF capacitor 114 to ground 109. All of the GND pins of voltage regulators 94 and 96 are coupled to GND109.

As previously noted, tilt module 50 optionally includes a tilt sensor 100 and an associated IC 102 for conditioning the output signals from tilt sensor 100. Tilt sensor 100 illustratively is an Orientation Systems type DX-016D-055 tilt sensor, and signal conditioning IC 102 illustratively is an Orientation Systems type EZ TILT 1000 IC. In this combination, A+5V 81 is coupled to the GAIN and VDD terminals, pins 2 and 14, respectively, of IC 102. VDD terminal is of IC 102 is also coupled through 0.1 μF capacitor 116 to GND 109. The DC RESTORE terminal, pin 3 of IC 102, is coupled though 1 MΩ resistor 118 to node 120. SENSOR_IN terminal, pins 18 of IC 102, is also coupled to node 120. The circuit 63 TiltRESET line 122 is coupled to the RESET terminal, pin 4, of IC 102.

The HEAD, FOOT, RIGHT, and LEFT terminals, pins 1, 3, 2, and 4, respectively, of tilt sensor 100, are coupled to the FR2P, FR2N, FRIP, FRIN, pins 10, 11, 8, and 9, respectively, of IC 102. COMmon terminal, pin 5 of IC 102, of tilt sensor 100 is coupled through 0.1 μF capacitor 126 to node 120. The INputCoMmanD and OUTputDATA terminals, pins 6 and 7, respectively, of IC 102 are coupled by the circuit 63's TILTCoMmanD and TILTDATA lines, 128 and 130, respectively, to RB4 and RB5 terminals, pins 25 and 26 respectively of μC 106. An 8 MHZ clock 104 provides a time base to the OSCI terminal, pin 16, of IC 102. As shown in FIG. 6, clock 104 is coupled through 33pF capacitors 131 to GND 109. The clock 104 is also coupled across the OSCI and OSC2 terminals, pins 9 and 10, respectively, of the tilt module 50's μC 106. μC 106 illustratively is a Microchip type PIC16C63-04-SO μC. The outputs from the FRONT LEFT, FRONT RIGHT, BACK LEFT and BACK RIGHT weight modules 134, 234, 334 and 434, respectively, are coupled to the RA0, RA1, RA2 and RA3 terminals, pins 2-5, respectively, of μC 106 through respective connectors 92 and a connector 108 on the tilt module circuit 63.

The TRESET and Serial Peripheral Interface notChipEnable (SPInCE) lines of circuit 63 are coupled to the RA4 and RA5 terminals, pins 6 and 7, respectively, of μC 106. The RB6 and RB7 terminals, pins 27 and 28, respectively, of μC 106 are coupled to the PROGramCLocK and PROGramDATA lines, respectively, of circuit 63. Terminals RC3, RC4, RC5, RC6 and RC7, pins 14-18, respectively, of μC 106 are coupled to the Serial Peripheral Interface Serial CLocK, Serial Peripheral Interface Serial Data Output, Serial Peripheral Interface Serial Data Input, transmit data (TXD), and receive data (RXD) lines, respectively, of circuit 62. The VPPnotRESET line of circuit 63 is coupled to the notMasterCLeaR/VPP terminal, pin 1, of μC 106. The SPI nCE, TRESET, VPPnRESET and SCLCLK lines are coupled through respective 10 KΩ pull-up resistors of resistive network 133 to D+5v 95. The PROG DATA line of circuit 63 is coupled through a 100 KΩ pull-up resistor to D+5V. D+5V is coupled to the VDD terminal, pin 20, of μC 106. The Vss terminals, pins 8 and 19, of μC 106, are coupled to GND.

The host 60 connection is completed by a twelve pin connector 120, pins 1-12 of which are respectively coupled to the GND, SPI SCLK, TXD, SCI CLK, SCI DATA, SPI nCE, PROG CLK, Vpp nRESET, RXD, SPI SDI, SPI SDO and +12V terminals of circuit 62.

As previously noted, tilt module 50 collects, combines and filters weight data from all weight modules 32 and transmits the result to host 60 using, for example, RS232. The tilt module 50 includes power conditioning circuitry, 94, 96 and associated components, and a μC 106. It can also include tilt sensor 100 and its associated signal conditioning IC 102. Due to the relatively higher cost of the tilt sensor 100 and its IC 102, the tilt module 50 can be produced in two versions, one with the tilt sensor components 100, 102 mounted on circuit board 62, and one without.

Turning now to FIG. 7, the tilt module 50 combines the output signals (shown as WMₙ, where n=1 through the number of weight modules 32, shown illustratively as n=4) from the various weight modules 32 and determines the weight on the mattress tray 26 as illustrated. The invention contemplates n weight modules 132, 232, . . . n32. Module 32, is described in detail, however, those skilled in the art will recognize that modules 132, 232 . . . , n32 are of similar construction.

Each module 32 receives a signal from its respective load cell 34 corresponding to the portion of the weight n39 (shown as arrows 139, 239, 339, and n39) on mattress tray 26 that its respective load cell 34 is supporting. The output signal 41 from load cell 34 is coupled to an input port of that respective weight module 32's instrumentation amplifier 84. The output signal 43 from the instrumentation amplifier 84 is coupled to an input port of the A/D converter 80. An output port of A/D converter 80 is coupled to an input port of μC 90. Other inputs to the μC 90 include a zero offset (b), which is a stored representative of a signal related to the deflection of the beam of load cell 34 with, for example, no infant on the mattress resting on mattress tray 26. This signal thus zeros out the load cell 34's portion of the weight of the mattress and any blankets, tubes, etc., which exert force on the load cell 34. Another input to the μC 90 is a gain factor (m), which is a stored representative proportional to the signal output from load cell 34 when a mass of, for example, 1 kilogram is applied to the load cell 34.

Output ports of all of the various μCs 190, 290, . . . n90 are coupled to input ports of the μC 106 of tilt module 50. Output ports of the tilt module 50's signal conditioning IC 102 are coupled to input ports of μC 106. Additional inputs to the μC 106 include a total_zero offset value related to the total platform 26 input during taring of the weight of the platform 26, mattress, blankets, tubes, etc., and a total₁₃ gain value related to the total platform 26 input generated during platform 26 calibration with, for example, a 5 kg mass resting on the platform 26. The total weight of the infant on the platform 26 can then be calculated as the tilt compensated filtered sum of the inputs from the weight modules 132, 232, . . . n32 times the total_gain value plus the total_zero value. The weights are sent from the μCs 190, 290, . . . n90 to μC 106 in the illustrated embodiment as 24-bit binary numbers in a serial communication format in order to enhance noise immunity of the system. μC 106 polls all of the μCs 190, 290, . . . n90 at once to send their detected loads synchronously and simultaneously in order to enhance patient motion artifact immunity.

As previously explained, each weight module 32 comprises an associated load cell 34, instrumentation amplifier 84, 24-bit A/D converter 80 and a μC 90. During calibration, μC 90 receives and stores the values of input signals indicative of the zero value (b) of weight module 32 and the value of the gain (m) of weight module 32. During operation, μC 90 receives input signals (X) indicative of the amount of deflection of the beam of load cell 34 caused by the portion of a patient's weight sensed by weight module 32, and command signals from the host. Illustratively, μC 90 uses a linear model to calculate the portion of the patient's weight sensed by weight module 32. The output of μC 90 includes a signal (Y=WMₙ) indicative of the portion of the patient's weight sensed by the module 32.

As previously mentioned, each μC 90 uses a linear model to calculate the portion of the patient's weight sensed by its associated weight module 32. That model can be represented in slope-y intercept form as:

Y=mX+b;

where Y is the portion of the patient's weight sensed by weight module 32, m is the slope established by the value of the gain of weight module 32, X is the signal indicative of the beam deflection of the load cell 34 (i.e. the amplified and digitized load cell output), and b is y-intercept representing the zero value of the weight module 32. The slope or weight module gain and the y-intercept or zero value of weight module 32 are determined during weight module calibration and are stored in μC 90.

When load cell 34 of weight module 32 supports a portion of the patient's weight, the beam of load cell 34 is deflected resulting in load cell 34 creating a differential voltage signal 41 typically in the microvolt range indicative of the beam deflection and the load. This differential voltage signal 41 is amplified by instrumentation amplifier 84 to create an amplified single-ended voltage signal 43 which is communicated to 24-bit A/D converter 80. A/D converter 80 converts the amplified single ended voltage signal 43 to a 24-Bit unsigned binary number which is serially or digitally available on the output of A/D converter 80 as a signal. This 24-bit signal provides the X signal, or signal indicative of beam deflection, to μC 90.

During calibration of weight module 32 the value of the 24 bit signal is determined when a zero gram load is applied to load cell 34. This value is the b, y-intercept or zero value of weight module 32 which is stored in μC 90. Also during calibration, load cell 34 is subjected to a 1000 gram load and the value of the 24 bit signal is determined. This value is stored as the value of the m, slope or weight module gain which is stored in μC 90. This calibration permits weight module 32 to normalize the computation of the portion of the patient's weight supported by module 32 by allowing the offset and gain to be corrected for load cell sensitivity, offset variations and circuitry errors.

Microcontroller 90 computes a 24 bit binary number, Y or WMₙ, indicative of the portion of the patient's weight which is supported by load cell 34. This 24 bit number is available at the output of μC 90 and is serially or digitally communicated to μC 106 of tilt module 50 for summing with the outputs of μCs 90 of the other weight modules 32. Illustratively, the tilt module 50 requests transmission of the outputs of the various weight modules 32 by broadcasting a request command over line 45 to μCs 90 of all weight modules 32. This broadcast request synchronizes the signal conversions of all weight modules 32 so that the various portions of the patient's weight are simultaneously calculated. By having each weight module 32 simultaneously calculate its respective portion of the patient's weight, errors resulting from patient motion are reduced or eliminated.

Referring to FIG. 7, tilt module 50 includes tilt sensor 100, signal conditioning IC 102, and μC 106. Microcontroller 106 receives signals from tilt sensor 100 and signal conditioning IC 102. Microcontroller also sends signals to and receives signals from each of the weight modules 32 and system host 60. Microcontroller 106 includes memory 47 capable of storing calibration information such as the total_zero value for total scale platform and total_gain for the total scale platform. The total_zero value is measured and stored during scale platform taring with the patient lifted off of the mattress. This measurement is accomplished by summing and correcting the input signals WMₙ received from all weight modules 32. The total_gain value is measured and stored during scale platform calibration with a 5 Kg weight on the mattress. Again, this measurement is accomplished by summing and correcting the input signals WMₙ received from all weight modules 32.

Tilt sensor 100 and signal conditioning IC 102 provide data to μC 90. Illustratively, this data includes digital mattress and scale platform tilt information including both front-back and right-left tilt directions. The range of sensitivity of the data provided is ±16 degrees from level with a resolution of 0.13 degrees. This range is sufficient for the illustrated device 20 which includes limiters prohibiting platform tilt of greater than 13 degrees from level either longitudinally or laterally. Those skilled in the art will recognize that the ranges and resolution described are illustrative and that tilt sensors 100 and signal conditioning ICs 102 having different ranges and resolution may be used in devices providing for greater or lesser lateral and longitudinal tilting or requiring higher or lower sensitivity.

Microcontroller 106, using the input from tilt sensor 100 and signal conditioning IC and the input from all weight modules 32 calculates the weight of the patient supported on the mattress using a moving window filtered linear model. Illustratively, this calculation is accomplished by summing the signals received from all weight modules 32 to determine the total force exerted perpendicular to the beam of all of the load cells 34. This summation of the weight module inputs is multiplied by the total₁₃ gain value determined during scale platform calibration and this product is added to the total_zero value determined during taring to create a linear model of the force exerted on all of the weight modules.

This linear model is then filtered by applying the tilt data received from the tilt sensor 100 and signal conditioning IC 102 to determine a current value of the weight of the patient supported on the mattress. The current value of the weight of the patient supported on the mattress is stored in memory. The current value of the weight of the patient supported on the mattress is summed with the previous seven weight values and averaged to establish a weight value to be displayed. Those skilled in the art will recognize that the number of previous weight values with which the current weight value is averaged may be increased or decreased within the scope of the disclosure.

Illustratively, the model used for weight determination by μC 106 is as follows:

$$TW = \frac{{\sum }_{current - z}^{current} ( cos θ ) ( cos φ ) [ total\_gain ( {\sum }_{1}^{n} {wm}_{n} ) + total\_zero ]}{z + 1}$$

where current is the current measurement, z is the number of previous measurements with which the current measurement will be averaged, TW is the calculated total weight, θ is the angle of head-foot tilt detected by tilt module 100, Φ is the angle left-right tilt detected by tilt sensor 100, total _gain is value measured and stored when a 5 kg mass is on the mattress during calibration, n is the number of weight modules 32, wmₙ is partial weight reading received from weight module n32, and total_zero is the value measured and stored during taring.

In the illustrated embodiment, all of the load cells 34 are mounted so that their load beams are substantially parallel. Thus, the forces exerted on each beam by the weight of the platform, mattress and patient are parallel. Therefore, since the direction of the force exerted on each beam is the same as the direction of the force exerted on all of the other beams, the magnitudes of the force components sensed by all of the load cells 34 can be added to establish a total magnitude of the force exerted perpendicular to the load beams. Therefore the digital signals received from all weight modules 32 are summed to determine a current measurement of force. The value of the force is determined by multiplying the summation by the total gain determined during calibration and adding the total_zero value determined during taring to establish a linear model of the current force sensed. The total force exerted by the patient (and all of the equipment that was lifted from the mattress during taring) on all load cells 32 has a direction equal to the direction of the tilt of the platform measured by tilt sensor 100.

The current force measurement is tilt adjustment filtered to find the current weight measurement. To determine the current weight measurement, the component of the force perpendicular to the earth is calculated by multiplying the current measured force by the cosine of the angle (θ) of head-foot tilt and by the cosine of the angle (Φ) of right-left tilt. The current weight measurement is further filtered by averaging it with several previous weight measurements to provide a weight measurement (TW) available to the system host 60 for display or other actions. In the illustrated embodiment, the current weight measurement is averaged with the seven previous weight measurements. Those skilled in the art will recognize that various data structures may be implemented in the memory of μC 106 to store the current and a sufficient number of prior weight measurements to implement the described moving window filter. Also, those skilled in the art will recognize that the weight measurement provided to the host may be the current weight measurement without the described moving window filtering.

Although the invention has been described in detail with reference to a certain preferred embodiment, variations and modifications exist within the scope and spirit of the present invention as described and defined in the following claims.

What is claimed is:

1. A patient scale including a patient support surface, a plurality of weight modules oriented between the support surface and a base, each of the weight modules producing at an output port thereof a digital signal, the weight modules being coupled to a host for providing an indication of the weight on the support surface, the digital signals being combined to produce an indication of the weight on the support surface.

2. The apparatus of claim 1 including four weight modules in a quadrilateral orientation between the support surface and the base.

3. The apparatus of claim 2 wherein in the four weight modules are oriented in a rectangle between the support surface and the base.

4. The apparatus of claim 1 further including a tilt module for decomposing signals from the weight modules into at least two components, one of the components corresponding to weight detected by that weight module, the signals being combined to produce an indication of the weight on the support surface.

5. The apparatus of claim 1 further including a module for filtering digital output signals from the weight modules.

6. The apparatus of claim 1 further including a module for summing digital output signals from the weight modules.

7. The apparatus of claim 4 wherein the tilt module also filters digital output signals from the weight modules.

8. The apparatus of claim 5 wherein the module for filtering digital output signals from the weight modules also sums digital output signals from the weight modules.

9. The apparatus of claim 4 wherein the tilt module also sums digital output signals from the weight modules.

10. The apparatus of claim 7 wherein the tilt module also sums digital output signals from the weight modules.

11. The apparatus of claim 1 wherein at least one of the weight modules includes an analog-to-digital (A/D) converter.

12. The apparatus of claim 11 wherein each weight modules includes an analog-to-digital (A/D) converter.

13. The apparatus of claim 1 wherein at least one of the weight modules includes a Faraday cylinder for shielding the at least one weight module from electrical fields outside the Faraday cylinder.

14. The apparatus of claim 13 wherein each of the weight modules includes a Faraday cylinder for shielding the weight module from electrical fields outside the Faraday cylinder.

15. The apparatus of claim 4 wherein the tilt module includes a first Faraday cylinder for shielding the tilt module from electrical fields outside the first Faraday cylinder.

16. The apparatus of claim 15 wherein at least one of the weight modules includes a second Faraday cylinder for shielding the at least one weight module from electrical fields outside the second Faraday cylinder.

17. The apparatus of claim 16 wherein each of the weight modules includes a second Faraday cylinder for shielding the weight modules from electrical fields outside its respective second Faraday cylinder.

18. The apparatus of claim 13 wherein the Faraday cylinders are electrically coupled to each other.

19. The apparatus of claim 16 wherein the first and second Faraday cylinders are electrically coupled to each other.

20. The apparatus of claim 17 wherein the first and second Faraday cylinders are electrically coupled to each other.

21. The apparatus of claim 5 wherein the module for filtering digital output signals from the weight modules includes a first Faraday cylinder for shielding the module from electrical fields outside the first Faraday cylinder.

22. The apparatus of claim 6 wherein the module for summing digital output signals from the weight modules includes a first Faraday cylinder for shielding the module from electrical fields outside the first Faraday cylinder.

23. The apparatus of claim 21 wherein at least one of the weight modules includes a second Faraday cylinder for shielding the at least one weight module from electrical fields outside the second Faraday cylinder.

24. The apparatus of claim 23 wherein each of the weight modules includes a second Faraday cylinder for shielding the weight modules from electrical fields outside its respective second Faraday cylinder.

25. The apparatus of claim 23 wherein the first and second Faraday cylinders are electrically coupled to each other.

26. The apparatus of claim 24 wherein the first and second Faraday cylinders are electrically coupled to each other.

27. A patient scale including a patient support surface, a plurality of weight modules oriented between the support surface and a base, at least one of the weight modules including a first Faraday cylinder for shielding the at least one weight module from electrical fields outside the first Faraday cylinder, the weight modules being coupled to a host for providing an indication of the weight on the support surface, output signals from the weight modules being combined to produce an indication of the weight on the support surface.

28. The apparatus of claim 27 wherein each of the weight modules includes a first Faraday cylinder for shielding the weight module from electrical fields outside its respective first Faraday cylinder.

29. The apparatus of claim 27 further including a tilt module for combining signals from the multiple weight modules.

30. The apparatus of claim 27 further including a module for filtering output signals from the weight modules.

31. The apparatus of claim 27 further including a module for summing signals from the weight modules.

32. The apparatus of claim 29 wherein the tilt module also filters output signals from the weight modules.

33. The apparatus of claim 30 wherein the module for filtering output signals from the weight modules also sums signals from the weight modules.

34. The apparatus of claim 29 wherein the tilt module sums signals from the weight modules.

35. The apparatus of claim 32 wherein the tilt module sums signals from the weight modules.

36. The apparatus of claim 28 wherein the Faraday cylinders are electrically coupled to each other.

37. The apparatus of claim 29 wherein the tilt module includes a second Faraday cylinder for shielding the tilt module from electrical fields outside the second Faraday cylinder.

38. The apparatus of claim 30 wherein the tilt module includes a second Faraday cylinder for shielding the tilt module from electrical fields outside the second Faraday cylinder.

39. The apparatus of claim 31 wherein the tilt module includes a second Faraday cylinder for shielding the tilt module from electrical fields outside the second Faraday cylinder.

40. The apparatus of claim 32 wherein the tilt module includes a second Faraday cylinder for shielding the tilt module from electrical fields outside the second Faraday cylinder.

41. The apparatus of claim 33 wherein the tilt module includes a second Faraday cylinder for shielding the tilt module from electrical fields outside the second Faraday cylinder.

42. The apparatus of claim 34 wherein the tilt module includes a second Faraday cylinder for shielding the tilt module from electrical fields outside the second Faraday cylinder.

43. The apparatus of claim 35 wherein the tilt module includes a second Faraday cylinder for shielding the tilt module from electrical fields outside the second Faraday cylinder.

44. The apparatus of claim 37 wherein the first and second Faraday cylinders are electrically coupled to each other.

45. The apparatus of claim 38 wherein the first and second Faraday cylinders are electrically coupled to each other.

46. The apparatus of claim 39 wherein the first and second Faraday cylinders are electrically coupled to each other.

47. The apparatus of claim 40 wherein the first and second Faraday cylinders are electrically coupled to each other.

48. The apparatus of claim 41 wherein the first and second Faraday cylinders are electrically coupled to each other.

49. The apparatus of claim 42 wherein the first and second Faraday cylinders are electrically coupled to each other.

50. The apparatus of claim 43 wherein the first and second Faraday cylinders are electrically coupled to each other.

51. A patient scale including a patient support surface, a plurality of weight modules oriented between the support surface and a base, each of the weight modules producing at an output port thereof a signal, the weight modules being coupled to a host for providing an indication of the weight on the support surface, a tilt module for separating the signals from the weight modules into at least two components, one of the components corresponding to the weight determined by each weight module, the signals being combined to produce an indication of the weight on the support surface.

52. The apparatus of claim 51 including four weight modules in a quadrilateral orientation between the support surface and the base.

53. The apparatus of claim 52 wherein in the four weight modules are oriented in a rectangle between the support surface and the base.

54. The apparatus of claim 51 wherein the tilt module also filters output signals from the weight modules.

55. The apparatus of claim 54 wherein the tilt module sums signals from the weight modules.

56. The apparatus of claim 51 wherein the tilt module sums signals from the weight modules.

57. The apparatus of claim 51 wherein at least one of the weight modules includes a first Faraday cylinder for shielding the weight module from electrical fields outside its respective first Faraday cylinder.

58. The apparatus of claim 57 wherein each of the weight modules includes a first Faraday cylinder for shielding the weight module from electrical fields outside its respective first Faraday cylinder.

59. The apparatus of claim 57 wherein the tilt module includes a second Faraday cylinder for shielding the tilt module from electrical fields outside the second Faraday cylinder.

60. The apparatus of claim 58 wherein the tilt module includes a second Faraday cylinder for shielding the tilt module from electrical fields outside the second Faraday cylinder.

61. The apparatus of claim 51 wherein the Faraday cylinders are electrically coupled to each other.

62. The apparatus of claim 52 wherein the Faraday cylinders are electrically coupled to each other.

63. The apparatus of claim 53 wherein the Faraday cylinders are electrically coupled to each other.

64. The apparatus of claim 54 wherein the Faraday cylinders are electrically coupled to each other.

65. The apparatus of claim 55 wherein the Faraday cylinders are electrically coupled to each other.

66. The apparatus of claim 56 wherein the Faraday cylinders are electrically coupled to each other.

67. The apparatus of claim 57 wherein the Faraday cylinders are electrically coupled to each other.

68. The apparatus of claim 58 wherein the Faraday cylinders are electrically coupled to each other.

69. The apparatus of claim 59 wherein the Faraday cylinders are electrically coupled to each other.

70. The apparatus of claim 60 wherein the Faraday cylinders are electrically coupled to each other.
